(19) United States
(12) Patent Application Publication
(10) Pub. No.: US 2026/0340882 A1
(43) Pub. Date: Oct. 29, 2026

(54) METHOD FOR UTILIZING V3C RAW PATCHES FOR COMPRESSION OF VOLUMETRIC PRIMITIVES

(71) Applicant: Nokia Technologies Oy, Espoo (FI)

(72) Inventors: Lauri Aleksi ILOLA, Tampere (FI); Lukasz KONDRAD, Munich (DE); Patrice RONDAO ALFACE, Antwerp (BE)

(21) Appl. No.: 19/657,816

(22) Filed: Apr. 24, 2026

Related U.S. Application Data
(60) Provisional application No. 63/795,171, filed on Apr. 25, 2025.

(51) Int. Cl. G06T 9/00; H04N 19/70

(52) U.S. Cl. CPC G06T 9/001; H04N 19/70

(57) ABSTRACT

An apparatus including a processor and a memory storing instructions that, when executed with the processor, cause the apparatus to perform: (i) receiving volumetric data, wherein the volumetric data consists of a plurality of three dimensional primitives corresponding to one or more three dimensional regions, (ii) packing quantized geometry and visual attributes of the three dimensional primitives of at least one three dimensional region of the plurality of three dimensional regions to at least one two dimensional region of a first image and at least one two dimensional region of a second image, (iii) forming at least one bitstream comprising the first image, the second image, and metadata, and signaling a profile in the metadata indicating that the quantized geometry and visual attributes of the three dimensional primitives were stored in two dimensional regions of the first and second image.

### TECHNICAL FIELD

The example and non-limiting embodiments relate generally to volumetric frame rendering and, more particularly, to image compression of volumetric rendering primitives.

### BRIEF DESCRIPTION OF PRIOR DEVELOPMENTS

There are many ways to capture and represent a volumetric scene. The format used to capture and represent a volumetric scene depends on the processing to be performed on it, and the target application using it.

### SUMMARY OF THE INVENTION

The following summary is merely intended to be an example. The summary is not intended to limit the scope of the claims.

In accordance with one aspect, an apparatus is provided comprising at least one processor and at least one memory storing instructions that, when executed with the at least one processor, cause the apparatus to perform: (i) receiving volumetric data, wherein the volumetric data consists of a plurality of three dimensional primitives corresponding to one or more three dimensional regions, (ii) packing quantized geometry and visual attributes of the three dimensional primitives of the at least one three dimensional region of the plurality of three dimensional regions to at least one two dimensional region of a first image and at least one two dimensional region of a second image without projecting the three dimensional primitives in two dimensional planes, (iii) forming at least one bitstream comprising the first image, the second image, and metadata, wherein the metadata indicates at least one relationship between the at least one three dimensional region and the at least one two dimensional region of the first image and the at least one two dimensional region of the second image, and (iv) signaling a profile in the metadata indicating that the quantized geometry and visual attributes of the three dimensional primitives in the at least one three dimensional regions were directly stored in the at least one two dimensional region in the first image and the at least one two dimensional region of the second image.

In accordance with another aspect, an apparatus is provided comprising at least one processor and at least one memory storing instructions that, when executed with the at least one processor, cause the apparatus to perform: (i) receiving at least one bitstream, the at least one bitstream comprising at least one two dimensional region of a first image, at least one two dimensional region of a second image, and metadata, (ii) decoding the at least one two dimensional region of the first image and the at least one two dimensional region of the second image based on an indication signaled by the profile in the metadata, and (iii) reconstructing volumetric data based at least in part on the profile in the metadata, and the metadata which indicates at least one relationship between at least one three dimensional region of the volumetric data and the at least one two dimensional region of the first image and the at least one two dimensional region of the second image.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 illustrates an example of a RAW patch and RAW coded points geometry layout in a geometry frame in accordance with example embodiments of the disclosure;

FIG. 3 illustrates an example of a RAW patch and RAW coded points attribute layout in an attribute frame in accordance with example embodiments of the disclosure;

FIG. 4 illustrates an example point cloud (e.g., a Gaussian Splat) in accordance with example embodiments of the disclosure;

FIGS. 5A and 5B illustrate example spherical harmonics (FIG. 5A) and a visual comparison with DCT basis functions (FIG. 5B) in accordance with example embodiments of the disclosure;

FIG. 6 illustrates projection-based compression of 3DGS in accordance with example embodiments of the disclosure;

FIGS. 7A and 7B illustrate mapping of a 3D region to two 2D regions that are mapped to at least two 2D frames in accordance with example embodiments of the disclosure;

FIGS. 8A and 8B illustrate mapping of a 3D region to two 2D regions that are mapped to at least two 2D frames in accordance with example embodiments of the disclosure;

FIGS. 9A and 9B illustrate mapping of a 3D region to two 2D regions that are mapped to at least two 2D frames in accordance with example embodiments of the disclosure;

FIG. 10 illustrates mapping of a 3D region to at least two 2D regions that are mapped to at least one 2D frame in accordance with example embodiments of the disclosure;

FIG. 11 illustrates splitting of a 3D region into sub-regions in accordance with example embodiments of the disclosure;

FIG. 12 illustrates a flow diagram in accordance with one or more example embodiments of the disclosure.

FIG. 13 illustrates a flow diagram in accordance with one or more example embodiments of the disclosure.

### DETAILED DESCRIPTION

The following abbreviations that may be found in the specification and/or the drawing figures are defined as follows:
1D one dimensional
2D two dimensional
3D three dimensional
BVH bounding volume hierarchy
DCT discrete cosine transform
G-PCC ISO/IEC 23090-9 geometry based point cloud compression
GS Gaussian splat
KL divergence Kullback-Leibler divergence
LOD level of detail
LUT look up table
PLAS parallel linear assignment sorting
RAHT region-adaptive hierarchical transform
SEI supplemental enhancement information
V3C visual volumetric video-based coding
V-PCC video-based point cloud compression

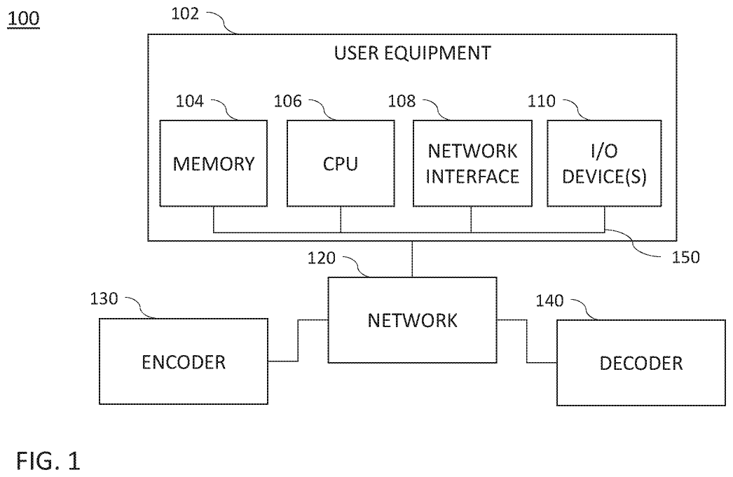

Referring to FIG. 1, this figure shows a block diagram 100 of one possible and non-limiting example in which the examples may be practiced. A user equipment (UE) 102, an encoder device 130, a decoder device 140, and a network 120 are illustrated. Examples of network equipment, network device, or a network entity might be understood to include, at least part of, a transmission reception point or a cell or a gNB or node for example. In the example of FIG. 1, the user equipment (UE) 102 may be in wireless communication with a wireless network 120. A UE may be a wireless device that can access the wireless network 100. The UE 102 includes one or more processors 106, one or more memories 104, one or more network interfaces 108, and one or more input/output device interfaces 110 interconnected through one or more buses 150. Each of the one or more network interfaces 108 may include a receiver, Rx, and a transmitter, Tx. The one or more buses 150 may be address, data, or control buses, and may include any interconnection mechanism, such as a series of lines on a motherboard or integrated circuit, fiber optics or other optical communication equipment, or the like. The one or more network interfaces 108 may be connected to one or more antennas. The one or more memories 104 may include computer program code. The UE 102 may include one or more modules. The modules 140 may be implemented in hardware, such as being implemented as part of the one or more processors 106. The module may be implemented also as an integrated circuit or through other hardware such as a programmable gate array. In another example, the module may be implemented as computer program code and may be executed by the one or more processors 106. For instance, the one or more memories 104 and the computer program code may be configured to, with the one or more processors 106, cause the user equipment 102 to perform one or more of the operations as described herein. The UE 102 may communicate with other user equipment (e.g., additional instantiations of UE 102) via wired or wireless network 120. Encoder 130 or Decoder 140 may include some, all, or additional features described in conjunction with UE 102. For example, Encoder 130 or Decoder 140 may be example instantiations of UE 102. In some embodiments, a UE 102 may have encoding and decoding capabilities as described herein.

The network 120 may include a network element or elements that may include core network functionality, and which provides connectivity via a link or links with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s), and note that both 5G and LTE functions might be supported.

The network 120 may be a wireless network configured to implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors and memories, and also such virtualized entities create technical effects.

The computer readable memories 104 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 104 may be means for performing storage functions. The processors 106 may be of any type suitable to the local technical environment, and may include one or more of general purpose computers, special purpose computers, microprocessors, digital signal processors (DSPs) and processors based on a multi-core processor architecture, as non-limiting examples. The processors 106 may be means for performing functions, such as controlling the UE 102, encoder device 130, decoder device 140, and other functions as described herein.

In general, the various embodiments of the user equipment 102 may include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

A volumetric frame may be represented as a point cloud. A point cloud is a set of unstructured points in 3D space, where each point is characterized by its position in a 3D coordinate system (e.g. Euclidean), and some corresponding attributes (e.g. color information provided as RGBA value, or normal vectors)

A volumetric frame may be represented as images, with or without depth, captured from multiple viewpoints in 3D space. In other words, the volumetric frame may be represented by one or more view frames where a view is a projection of a volumetric scene on to a plane (the camera plane) using a real or virtual camera with known/computed extrinsic and intrinsic values. Each view may be represented by a number of components (e.g. geometry, color, transparency, and occupancy picture), which may be part of the geometry picture or represented separately.

A volumetric frame may be represented as a mesh. Mesh is a collection of points, called vertices, and connectivity information between vertices, called edges. Vertices along with edges form faces. The combination of vertices, edges and faces may uniquely approximate shapes of objects.

A volumetric frame may be represented as a radiance field, i.e., a representation of rays of light in the scene (sometimes referred to as the plenoptic function or light fields etc.), that may be captured for example by multiple viewpoints such as provided by a number of light field cameras or a number of omnidirectional or plenoptic cameras. Several radiance field representations are described in the following.

A volumetric frame may be represented as an implicit and learned neural radiance field such as the Neural Radiance Field (NeRF) representation for example. A NeRF is a representation of a 3D scene that is parameterized by a deep neural network (DNN). The network predicts a volume density and view-dependent emitted radiance given the spatial location (x, y, z) and viewing direction, e.g., in Euler angles (θ, φ, ψ) of the camera. Volume rendering techniques may produce an image by sampling points along rays intercepted by the camera projection model.

A volumetric frame may be represented as a learned radiance field such as the Gaussian Splatting (a.k.a., 3DGS, 4DGS, Gaussian Splat) representation. This representation may be seen as a point cloud representation with additional attributes that model the geometry and appearance of the scene in the close neighborhood of a position (x, y, z). Rendering of radiance fields represented as Gaussian splats and other variants using modified versions of the attributes may be performed by simple and fast rasterization or more accurate volume rendering using ray tracing.

Depending on the capture, a volumetric frame may provide viewers the ability to navigate a scene with six degrees of freedom, i.e., both translational and rotational movement of their viewing pose (which includes yaw, pitch and roll). The data to be coded for a volumetric frame may also be significant, as a volumetric frame may contain large numbers of objects, and the positioning and movement of these objects in the scene may result in many dis-occluded regions. Furthermore, the interaction of light and materials in objects and surfaces in a volumetric frame may generate complex light fields that may produce texture variations for even a slight change of pose.

A sequence of volumetric frames is a volumetric video. Due to large amount of information, storage and transmission of a volumetric video requires compression.

A point cloud is a data structure that may be used to represent a three-dimensional scene. Point clouds consist of a set of points in a coordinate system. Each point is defined by its three coordinates and may be associated with zero or more attributes. Attributes may have different types and are used to describe the properties of a point, such as its color or reflectance. Point clouds may be created by sensors such as Lidar (“light detection and ranging”) or Radar (“radio detection and ranging”) sensors or by depth cameras or by multi-camera setups or by ultrasound devices or by other distance sensing devices or combinations one or more of the above and, optionally, other devices. There are many use-case scenarios for point clouds. An example use case is a vehicle that uses one or multiple sensors to scan its environment to create a point cloud describing its surroundings. The point clouds may then be used for further processing. For example, for creating a virtual mapping of the environment, for autonomous driving use cases, or for teleoperation. In some cases, further processing has to be done on a device different from the one that captured the point cloud. In those cases, point clouds or sequences of point clouds have to be transmitted over a network. Due to the large amount of data that point cloud sequences produce, transmitting the data in real-time is challenging. In addition to the use of efficient codecs to reduce the data rate, it may be beneficial to lower the bandwidth requirements by prioritizing certain parts of a point cloud and allowing other parts to be removed from the point cloud before transmission. Moreover, transmission channels (such as wireless networks, packet networks, or other potentially unreliable channels) may not deliver all point cloud data intact, in which case, possibly selective, repair mechanisms may be beneficial.

In some embodiments, visual volumetric video-base coding (V3C), as defined by the standard ISO/IEC 23090-5, may be used for coding volumetric video. ISO/IEC 23090-5 specifies the syntax, semantics, and process for coding volumetric video. The specified syntax is designed to be generic so that it may be reused for a variety of applications. Point clouds, immersive video with depth, and mesh representations can all use the ISO/IEC 23090-5 standard with extensions that deal with the specific nature of the final representation. The disclosed embodiments define how to decode and interpret the associated data (for example atlas data in ISO/IEC 23090-5) which tells a renderer how to interpret 2D frames to reconstruct a volumetric frame. The disclosed embodiments are described using the standard ISO/IEC 23090-5 for illustrative purposes only, it is understood that other video coding standards may be used.

Standard ISO/IEC 23090-5 defines syntax and semantics of raw patches. Raw patches are a particular type of patches that may be stored in a V3C-derived specification, which allows to store raw x,y,z values of the position directly in a video frame without projection. This feature is generally intended for storing points that are difficult to capture in projection planes accurately due to their sparse or high-frequency neighborhood. The raw patch definition in ISO/IEC 23090-5 describes a region (patch) in a video frame (rpdu_2d_pos_x, rpdu_2d_pos_y, rpdu_2d_size_x_minus1, rpdu_2d_size_y_minus1), which contains a certain number of points (rpdu_points_minus1). Additional 3D offset (rpdu_3d_offset_u, rpdu_3d_offset_v, rpdu_3d_offset_d) may be be defined to displace the points in the patch to allow fitting of the 3D position of the point values in the video frames and to improve compression performance.

The syntax of the raw patches is described in the Table 1. Raw patches may be patches, where information about the points may be stored directly without projection.

TABLE 1
Raw patch data unit syntax in a tabular form

| | Descriptor |
|---|---|
| raw_patch_data_unit( tileID, patchIdx ) { | |
| if( AuxTileHeight[ TileIDToIndex[ tileID ] ] > 0) | |
| rpdu_patch_in_auxiliary_video_flag[ tileID ][ | u(1) |
| patchIdx ] | |
| rpdu_2d_pos_x[ tileID ][ patchIdx ] | ue(v) |
| rpdu_2d_pos_y[ tileID ][ patchIdx ] | ue(v) |
| rpdu_2d_size_x_minus1[ tileID ][ patchIdx ] | ue(v) |
| rpdu_2d_size_y_minus1[ tileID ][ patchIdx ] | ue(v) |
| rpdu_3d_offset_u[ tileID ][ patchIdx ] | u(v) |
| rpdu_3d_offset_v[ tileID ][ patchIdx ] | u(v) |
| rpdu_3d_offset_d[ tileID ][ patchIdx ] | u(v) |
| rpdu_points_minus1[ tileID ][ patchIdx ] | ue(v) |
| } | |

### Key Definitions:

rpdu_patch_in_auxiliary_video_flag[tileID][p] specifies whether the geometry and attribute data associated with the RAW coded patch with index p in the current atlas tile, with tile ID equal to tileID, are encoded in an auxiliary video sub-bitstream. If rpdu_patch_in_auxiliary_video_flag[tileID][p] is equal to 0, the geometry and attribute data associated with the RAW coded patch p in the current atlas tile are encoded in the corresponding 1 st non map auxiliary video sub-bitstream. If rpdu_patch_in_auxiliary_video_flag[tileID][p] is equal to 1, the geometry and attribute data associated with the RAW coded patch p in the current atlas tile are encoded in the corresponding auxiliary video sub-bitstream. If rpdu_patch_in_auxiliary_video_flag[tileID][p] is not present, its value shall be inferred to be equal to 0.

rpdu_2d_pos_x[tileID][p] specifies the x-coordinate of the top-left corner of the patch bounding box size for the RAW coded patch p in the current atlas tile, with tile ID equal to tileID, expressed as a multiple of PatchPackingBlockSize.

rpdu_2d_pos_y[tileID][p] specifies the y-coordinate of the top-left corner of the patch bounding box size for the RAW coded patch p in the current atlas tile, with tile ID equal to tileID, expressed as a multiple of PatchPackingBlockSize.

rpdu_2d_size_x_minus1[tileID][p] plus 1 specifies the width value of the RAW coded patch with index p in the current atlas tile, with tile ID equal to tileID.

rpdu_2d_size_y_minus1[tileID][p] plus 1 specifies the height value of the RAW coded patch with index p in the current atlas tile, with tile ID equal to tileID.

rpdu_3d_offset_u [tileID][p] specifies the shift to be applied to the reconstructed RAW patch points in the patch with index p of the current atlas tile, with tile ID equal to tileID, along the tangent axis. The number of bits used to represent rpdu_3d_offset_u [tileID][p] is (ath_raw_3d_offset_axis_bit_count_minus1+1).

rpdu_3d_offset_v [tileID][p] specifies the shift to be applied to the reconstructed RAW patch points in the patch with index p of the current atlas tile, with tile ID equal to tileID, along the bi-tangent axis. The number of bits used to represent rpdu_3d_offset_v [tileID][p] is (ath_raw_3d_offset_axis_bit_count_minus1+1).

rpdu_3d_offset_d [tileID][p] specifies the shift to be applied to the reconstructed RAW patch points in the patch with index p of the current atlas tile, with tile ID equal to tileID, along the normal axis. The number of bits used to represent rpdu_3d_offset_d [tileID][p] is (ath_raw_3d_offset_axis_bit_count_minus1+1).

rpdu_points_minus1[tileID][p] plus 1 specifies the number of RAW points present in the RAW coded patch with index p in the current atlas tile, with tile ID equal to tileID. The value of rpdu_points_minus1[tileID][p] shall be in the range of 0 to ((rpdu_2d_size_x_minus1[tileID][p]+1)*(rpdu_2d_size_y_minus1[tileID][p]+1))/3−1, inclusive.

Reconstruction of RAW patches is provided by the ISO/IEC 23090-5 standard. Example inputs to this process include:
a variable pointCnt, the number of points in the reconstructed point cloud frame,
a variable pIdx, the index of the patch,
a variable frameHeight, the height of the decoded geometry and possibly decoded attributes frames,
a variable frameWidth, the width of the decoded geometry and possibly decoded attributes frames,
a 1D array pointToPatch, of size pointCnt, specifying the patch index for the reconstructed point,
a 2D array pointToPixel, of size pointCnt×2, specifying the atlas coordinates for the reconstructed point,
a 1D array attrPresent, of size pointCnt, specifying whether the attribute values for a reconstructed point are present in the attribute video bitstream,
a 2D array gFrame, of size frameHeight×frameWidth, specifying the decoded geometry frames in the nominal format, and
a 2D array recPcGeo, of size pointCnt×3, specifying a list of coordinates of the points in the reconstructed point cloud frame.

Additionally, when ai_attribute_count[RecAtlasID] is greater than 0, the inputs to this process may include:
a 4D array aFrame, of size
attribute_count[RecAtlasID]×ai_attribute_dimension_minus1[RecAtlasID][attrIdx]×frameHeight×frameWidth, specifying the decoded attribute frames in the nominal format, and
a 3D array recPcAttr, of size
pointCnt×ai_attribute_count[RecAtlasID]×ai_attribute_dimension_minus1[RecAtlasI D][attrIdx], specifying a list of attributes associated with the points in the reconstructed point cloud frame.

Outputs of this process may include:
the modified variable pointCnt,
the modified array pointToPatch,
the modified array pointToPixel,
the modified array attrPresent,
the modified array recPcGeo, and
the modified array recPcAttr.

The 3D coordinates of a RAW coded point may be retrieved from the first map of the first component of the geometry frame containing the RAW patch corresponding to the RAW coded point, and the point is added to recPcGeo. The attribute information for the RAW coded point may be retrieved from the attribute frame containing the RAW patch corresponding to the RAW coded point, across the different attribute dimensions at the same location and added to recPcAttr. This may be accomplished as follows:

An array rawPos1D[m] where m is in the range of 0 to 3*AtlasPatchRawPoints[pIdx]−1, inclusive, is initialized to 0.

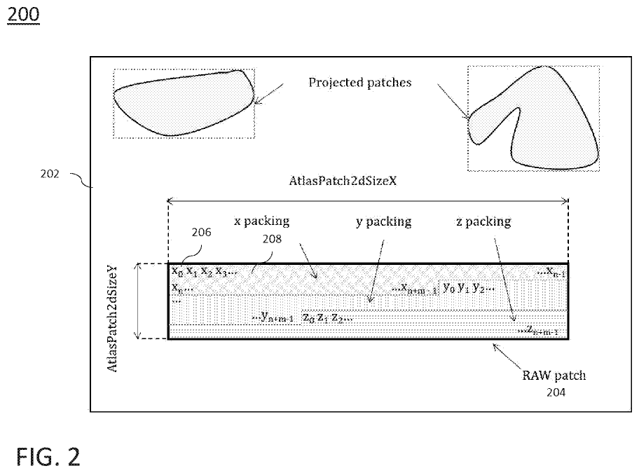

FIG. 2 shows, in diagram 200, an example RAW patch 204 in a geometry frame 202, where the coordinates of 3D points represented by RAW coded points 206 are each packed contiguously in the first component 208 of geometry frame 202.

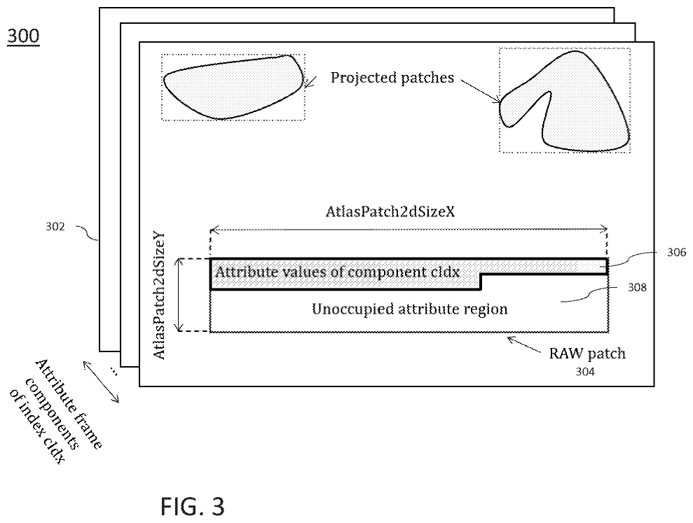

FIG. 3 shows, in diagram 300, an example RAW patch 304 in an attribute frame 302 where RAW attribute values are stored in raster scan order for each component of index cIdx 306.

V3C allows packing multiple video components in the same frame to reduce the number of video decoders needed when decoding the volumetric video. The describes the syntax of the packing_information( ) structure, that describes how different video components may be packed in the same frame.

TABLE 2
Packed information syntax structure as defined in 23090-5

| | Descriptor |
|---|---|
| packing_information( j ) { | |
| pin_codec_id[ j ] | u(8) |
| pin_occupancy_present_flag[ j ] | u(1) |
| pin_geometry_present_flag[ j ] | u(1) |
| pin_attribute_present_flag[ j ] | u(1) |
| if( pin_occupancy_present_flag[ j ] ) { | |
| pin_occupancy_2d_bit_depth_minus1[ j ] | u(5) |
| pin_occupancy_msb_align_flag[ j ] | u(1) |
| pin_lossy_occupancy_compression_threshold[ j ] | u(8) |
| } | |
| if( pin_geometry_present_flag[ j ] ) { | |
| pin_geometry_2d_bit_depth_minus1[ j ] | u(5) |
| pin_geometry_msb_align_flag[ j ] | u(1) |
| pin_geometry_3d_coordinates_bit_depth_minus1[ j ] | u(5) |
| } | |
| if( pin_attribute_present_flag[ j ] ) { | |
| pin_attribute_count[ j ] | u(7) |
| for( i = 0; i < pin_attribute_count[ j ]; i++ ) { | |
| pin_attribute_type_id[ j ][ i ] | u(4) |
| pin_attribute_2d_bit_depth_minus1[ j ][ i ] | u(5) |
| pin_attribute_msb_align_flag[ j ][ i ] | u(1) |
| pin_attribute_map_absolute_coding_persistence_flag[ j ][ i ] | u(1) |
| d = pin_attribute_dimension_minus1[ j ][ i ] | u(6) |
| if( d == 0 ) { | |
| pin_attribute_dimension_partitions_minus1[ j ][ i ] = 0 | |
| m = 0 | |
| } else | |
| m = pin_attribute_dimension_partitions_minus1[ j ][ i ] | u(6) |
| for( k = 0; k < m; k++ ) { | |
| if( k + d == m ) { | |
| pin_attribute_partition_channels_minus1[ j ][ i ][ k ] = 0 | |
| n = 0 | |
| } else | |
| n = pin_attribute_partition_channels_minus1[ j ][ i ][ k ] | ue(v) |
| d -= n + 1 | |
| } | |
| pin_attribute_partition_channels_minus1[ j ][ i ][ m ] = d | |
| } | |
| } | |
| pin_regions_count_minus1[ j ] | ue(v) |
| for( i = 0; i <= pin_regions_count_minus1[ j ]; i++ ) { | |
| pin_region_tile_id[ j ][ i ] | u(8) |
| pin_region_type_id_minus2[ j ][ i ] | u(2) |
| pin_region_top_left_x[ j ][ i ] | u(16) |
| pin_region_top_left y[ j ][ i ] | u(16) |
| pin_region_width_minus1[ j ][ i ] | u(16) |
| pin_region_height_minus1[ j ][ i ] | u(16) |
| pin_region_unpack_top_left_x[ j ][ i ] | u(16) |
| pin_region_unpack_top_left_y[ j ][ i ] | u(16) |
| pin_region_rotation_flag[ j ][ i ] | u(1) |
| if( pin_region_type_id_minus2[ j ][ i ] + 2 == V3C_AVD \|\| | |
| pin_region_type_id_minus2[ j ][ i ] + 2 == V3C_GVD ) { | |
| pin_region_map_index[ j ][ i ] | u(4) |
| pin_region_auxiliary_data_flag[ j ][ i ] | u(1) |
| } | |
| if( pin_region_type_id_minus2[ j ][ i ] + 2 == V3C_AVD ) { | |
| pin_region_attr_index[ j ][ i ] | u(7) |
| k = pin_region_attr_index[ j ][ i ] | |
| if( pin_attribute_dimension_minus1[ j ][ k ] > 0 ) | |
| pin_region_attr_partition_index[ j ][ i ] | u(5) |
| } | |
| } | |
| } | |

Packed video frames may be divided into one or more rectangular regions. One region shall be mapped to exactly one atlas tile. The rectangular regions of a packed video frame are not allowed to overlap.

pin_codec_id[j] indicates a mapping index of a codec identifier of the video decoder used to decode the packed video sub-bitstream, if present, for the atlas with ID j, as specified in subclause 9.6. pin_codec_id[j] shall be in the range of 0 to 255, inclusive.

pin_occupancy_present_flag[j] equal to 0 indicates that packed video frames of the atlas with atlas ID j do not contain regions with occupancy data. pin_occupancy_present_flag[j] equal to 1 indicates that packed video frames of the atlas with atlas ID j do contain regions with occupancy data. When pin_occupancy_present_flag[j] is not present, its value is inferred to be equal to 0.

It is a requirement of bitstream conformance that if pin_occupancy_present_flag[j] is equal to 1 for an atlas with atlas ID j, vps_occupancy_video_present_flag[j] shall be equal to 0 for an atlas with the same atlas ID j.

pin_geometry_present_flag[j] equal to 0 indicates that packed video frames of the atlas with atlas ID j do not contain regions with geometry data. pin_geometry_present_flag[j] equal to 1 indicates that packed video frames of the atlas with atlas ID j do contain regions with geometry data. When pin_geometry_present_flag[j] is not present, its value is inferred to be equal to 0.

It is a requirement of bitstream conformance that if pin_geometry_present_flag[j] is equal to 1 for an atlas with atlas ID j, vps_geometry_video_present_flag[j] shall be equal to 0 for an atlas with the same atlas ID j.

pin_attribute_present_flag[j] equal to 0 indicates that packed video frames of the atlas with atlas ID j do not contain regions with attribute data. pin_attribute_present_flag[j] equal to 1 indicates that packed video frames of the atlas with atlas ID j do contain regions with attribute data. When pin_attribute_present_flag[j] is not present, its value is inferred to be equal to 0.

It is a requirement of bitstream conformance that if pin_attribute_present_flag[j] is equal to 1 for an atlas with atlas ID j, vps_attribute_video_present_flag[j] shall be equal to 0 for an atlas with the same atlas ID j.

pin_occupancy_2d_bit_depth_minus1[j] plus 1 indicates the nominal 2D bit depth to which the decoded regions containing occupancy data for the atlas with atlas ID j shall be converted. pin_occupancy_msb_align_flag[j] shall be in the range of 0 to 31, inclusive.

pin_occupancy_msb_align_flag[j] indicates how the decoded regions containing occupancy samples associated with an atlas with atlas ID j are converted to samples at the nominal occupancy bit depth, as specified in Annex B.

pin_lossy_occupancy_compression_threshold[j] indicates the threshold to be used to derive the binary occupancy from the decoded regions containing occupancy data for the atlas with atlas ID j, as specified in Annex B. pin_lossy_occupancy_compression_threshold[j] shall be in the range of 0 to 255, inclusive.

pin_geometry_2d_bit_depth_minus1[j] plus 1 indicates the nominal 2D bit depth to which the decoded regions containing geometry data for the atlas with atlas ID j shall be converted. pin_geometry_2d_bit_depth_minus1[j] shall be in the range of 0 to 31, inclusive.

pin_geometry_msb_align_flag[j] indicates how the decoded regions containing geometry samples associated with an atlas with atlas ID j are converted to samples at the nominal occupancy bit depth, as specified in Annex B.

pin_geometry_3d_coordinates_bit_depth_minus1[j] plus 1 indicates the bit depth of the geometry coordinates of the reconstructed volumetric content for the atlas with atlas ID j. pin_geometry_3d_coordinates_bit_depth_minus1[j] shall be in the range of 0 to 31, inclusive.

pin_attribute_count[j] indicates the number of attributes with unique attribute types present in packed video frames for the atlas with atlas ID j. pin_attribute_count[j] shall be in the range of 1 to 127, inclusive.

pin_attribute_type_id[j][i] indicates the attribute type of the attribute with attribute with index i, for the atlas with atlas ID j. Table 5 describes the list of supported attributes types.

pin_attribute_2d_bit_depth_minus1[j][i] plus 1 indicates the nominal 2D bit depth to which the regions containg attribute with attribute index i, for the atlas with atlas ID j, shall be converted. pin_attribute_2d_bit_depth_minus1[j][i] shall be in the range of 0 to 31, inclusive.

pin_attribute_msb_align_flag[j][i] indicates how the decoded regions containing attribute with attribute index i, for the atlas with atlas ID j, are converted to samples at the nominal attribute bit depth, as specified in Annex B.

pin_attribute_map_absolute_coding_persistence_flag[j][i] equal to 1 indicates that the decoded regions containing attribute maps, for the attribute with index i, that correspond to the atlas with atlas ID j, are coded without any form of map prediction. pin_attribute_map_absolute_coding_persistence_flag[j][i] equal to 0 indicates that the decoded regions containing attribute maps of the attribute with index i, that correspond to the atlas with atlas ID j, shall use the same map prediction method as used for the geometry component of the atlas with atlas ID j. If pin_attribute_map_absolute_coding_persistence_flag[j][i] is not present, its value shall be inferred to be equal to 1.

The 3D array AttributeMapAbsoluteCodingEnabledFlag, which indicates if a particular map of an attribute is to be coded with or without prediction, is obtained as follows:

if( pin_attribute_map_absolute_coding_persistance_flag[ j ][ i ] == 1) {

for( k = 0; k < vps_map_count_minus1[ j ]; k++ )

PackingAttributeMapAbsoluteCodingEnabledFlag[ j ][ i ][ k ] = 1

}
else{

for( k = 0; k < vps_map_count_minus1[ j ]; k++ )

PackingAttributeMapAbsoluteCodingEnabledFlag[ j ][ i ][ k ] =

vps_map_absolute_coding_enabled_flag[ j ][ i ]

}

pin_attribute_dimension_minus1[j][i] plus 1 indicates the total number of dimensions (i.e., number of channels) of the regions containg attribute with index i, for the atlas with atlas ID j. pin_attribute_dimension_minus1[j][i] shall be in the range of 0 to 63, inclusive.

pin_attribute_dimension_partitions_minus1[j][i] plus 1 indicates the number of partition groups in which the attribute channels of the regions containg attribute with index i, for the atlas with atlas j, ID should be grouped in. pin_attribute_dimension_partitions_minus1[j][i] shall be in the range of 0 to 63, inclusive.

pin_attribute_partition_channels_minus1[j][i][k] plus 1 indicates the number of channels assigned to the dimension partition group with index k, of the regions containg attribute with index i, for the atlas with atlas ID j. ai_attribute_partition_channels_minus1[j] [i][k] shall be in the range of 0 to pin_attribute_dimension_minus1[j][i], inclusive, for all dimension partition groups.

pin_regions_count_minus1[j] plus 1 indicates the number of regions packed in one video frame for the atlas with ID j. pin_regions_count_minus1 shall be in the range of 0 to 255, inclusive.

pin_region_tile_id[j][i] indicates the atlas tile ID, of the atlas with ID j, corresponding to the region with index i.

pin_region_type_id_minus2 [j][i] plus 2 indicates the ID of the region with index i for the atlas with ID j. The value of pin_region_type_id_minus2 [j][i] shall be in the range of 0 to 2, inclusive.

pin_region_top_left_x[j][i] specifies the horizontal position of the top left sample of the region with index i for the atlas with ID j in unit of luma samples in the packed video component frame

pin_region_top_left_y[j][i] specifies the vertical position of top left sample of the region with index i for the atlas with ID j in unit of luma samples in in the packed video component frame.

pin_region_width_minus1[j][i] plus 1 specifies the width of the region with index i for the atlas with ID j in units of luma samples.

pin_region_height_minus1[j][i] plus 1 specifies the height of the region with index i for the atlas with ID j in units of luma samples.

pin_region_unpack_top_left_x[j][i] specifies the horizontal position of the top left sample of the region with index i for the atlas with ID j in unit of luma samples in the unpacked video component frame.

pin_region_unpack_top_left_y[j][i] specifies the vertical position of the top left sample of the region with index i for the atlas with ID j in unit of luma samples in the unpacked video component frame.

pin_region_rotation_flag[j][i] equal to 0 indicates that no rotation on the region with index i for the atlas with ID j is performed. pin_region_rotation_flag[j][i] equal to 1 indicates that the region with index i for the atlas with ID j is rotated 90 degrees.

pin_region_map_index[j][i] specifies the map index of the region with index i of the atlas with ID j.

pin_region_auxiliary_data_flag[j][i] equal to 1 indicates that the region with index i of the atlas with ID j contains RAW and/or EOM coded points only. pin_region_auxiliary_data_flag equal to 0 indicates that the region with index i of the atlas with ID j may contains RAW and/or EOM coded points.

pin_region_attr_index[j][i] indicates the attribute index of the region with index i of the atlas with ID j. The value of pin_region_attr_index[j][i] shall be in the range of 0 to pin_attribute_count[j]−1, inclusive.

pin_region_attr_partition_index[j][i] indicates the attribute partition index of the region with index i of the atlas with ID j. When not present, the value of pin_region_attr_partition_index[j][i] is inferred to be equal to 0.

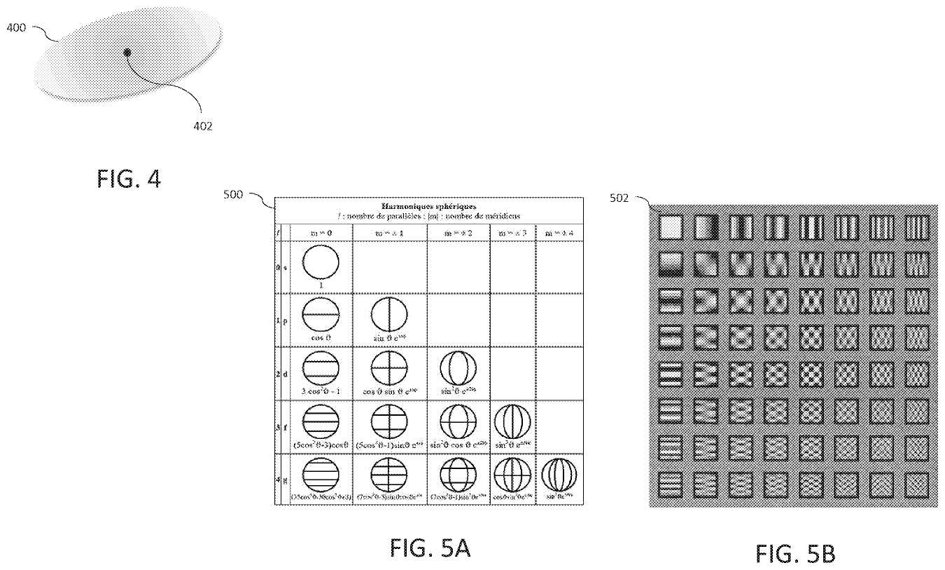

Gaussian splats may be seen as point clouds with additional attributes as illustrated in FIG. 4.
Attributes of the Gaussian Splats include, for example:
   Position (x,y,z)
   Scale (sx,sy,sz); i.e., non-uniform scale factor of the Gaussian splat
   Rotation (rx,ry,rz) or (qx,qy,qz,qw); i.e., the rotation of the Gaussian splat with respect to world coordinates, the rotation is expressed by Euler angles or quaternions
Optionally, Normal (nx, ny, nz); i.e., the normal vector of the Gaussian splat
   Opacity (alpha), i.e., a factor that indicates the transparency of the Gaussian splat
   Color (r,g,b), i.e., the primary color of the Gaussian splat
Spherical harmonics (e.g. SH[0:48]), i.e., the reflectance of the Gaussian splat expressed in spherical harmonics

In some embodiments, color may be represented by the DC component of spherical harmonics, and spherical harmonics contain 45 non-DC components. Spherical harmonics may be be seen as DCT basis functions defined on the sphere (see FIG. 5).

The rendering function for a Gaussian splat is as follows:

$${g}_{i} ( p ) = α exp ( - \frac{1}{2} ( p - {μ}_{i} ) {\sum }_{i}^{- 1} ( p - {μ}_{i} ) )$$

Where Σ is the covariance matrix and is equal to:

Σ=RSS^{T}R^{T}

Where R is a 3×3 rotation matrix expressed with 4 quaternions and S is a diagonal scaling matrix with 3 parameters for scale.

FIG. 4 illustrates an example Gaussian Splat 400. The position information is the one of its center highlighted by a circle 402. The size and orientation of the shape of splat 400 may be determined by, for example, scale and rotation. The color, transparency and reflectivity may be defined by the spherical harmonics and opacity.

FIG. 5A illustrates example Spherical Harmonics 500. FIG. 5B illustrates a visual comparison with DCT basis functions in 502. Similarly to DCT that enables low to high frequency variations on the horizontal and vertical axis of an image, increasing order of spherical harmonics shows increasing frequency variations in vertical and horizontal directions on the sphere. The first component (m=0, 1=0), referred to as DC represents a constant value over the sphere, the second component (m=0, 1=1) enables a variation from south pole to north pole following cos (theta), the third component enables a variation from one side of the equator to the other side, etc. Multiplying the three color components RGB to these 15 basis functions on the sphere leads to 45 spherical harmonics components as illustrated in FIGS. 5A and 5B. Some approaches achieve a fast estimation of the Spherical harmonics transform and inverse transform by relying on the FFT.

Other variants of radiance fields representations may include:
Spherical point clouds, which are similar to Gaussian splats except that the shape is spherical, i.e., there is only one scale factor and there is no rotation attribute data and no falloff due to the gaussian probability distribution.
Ellipsoids, while sharing similar attributes with Gaussian splats, the rendering includes a cut-off at the ellipsoid scale-driven boundary and a constant opacity in the ellipsoid.
Billboards, where the attributes are common with Gaussian splats but the rendering equation is defined on a rectangle.
2DGS or surfels, similar to Gaussian splats but where the smallest scale is set to zero and a normal is defined. These are typically defined on surfaces in the tangent space. The rendering equation is the same as for Gaussian splats.
Gaussian splats with neural appearance attributes, where view dependent appearance is represented by latent variables. The rendering equation requires a MLP to decode the latent appearance.
Meshlets, small meshes with little topological variations. Meshlets may come with single material where view dependent color information is baked (i.e. spherical harmonics) or they may come with textures which contain several different colors and varying level of support for baked view dependent effects.

Some variants of Gaussian splats do not explicitly encode a unique center position with extra attributes, but do not prevent from coding or deriving such center position. For example, billboards of Gaussian Textures describe a rectangular tile on which the Gaussian splat representation is defined instead of a single central point. Another example is 3D Convex Splatting (3DCS) that encode a polygonal shape containing N points without encoding any central position. Nevertheless, the appearance attributes are similar to 3DGS as well as the rendering and learning strategy used to model those from input camera views.

Gaussian splats may be coded using different formats. An example of a coding format that is available for Gaussian splat coding is a .spz file format for static Gaussian splats. The .spz file format is a gzipped stream of data consisting of a 16-byte header followed by the gaussian data. This data may be organized by attribute in the following order: positions, scales, rotations, alphas, colors, and spherical harmonics.

Table 3 lists different types of primitives that may be assigned an index code for shorter expression. The list may be extended with new primitive types.

TABLE 3

| primitive_type Index | Primitive type |
|---|---|
| 0 | 3D Gaussian Splat |
| 1 | 2D Gaussian Splat |
| 2 | Ellipsoids |
| 3 | Spheres |
| 4 | Billboards/Planes |
| 5 | Convex shapes |
| 6 | Generalized Gaussians |
| 7 . . . 15 | RESERVED |

Throughout the disclosure, descriptors are used to specify the parsing process of a syntax element. The descriptor definition is same as in ISO/IEC 23090-5, for example:

u(n): unsigned integer using n bits. When n is “v” in the syntax table, the number of bits varies in a manner dependent on the value of other syntax elements. The parsing process for this descriptor is specified by the return value of the function read_bits(n), specified in ISO/IEC 23090-5, interpreted as a binary representation of an unsigned integer with the most significant bit written first. When n is equal to 0, the associated syntax element is not present in the bitstream and its corresponding value shall be inferred to be equal to 0 unless specified otherwise in the semantics.

ue(v): unsigned integer 0-th order Exp-Golomb-coded syntax element with the left bit first.

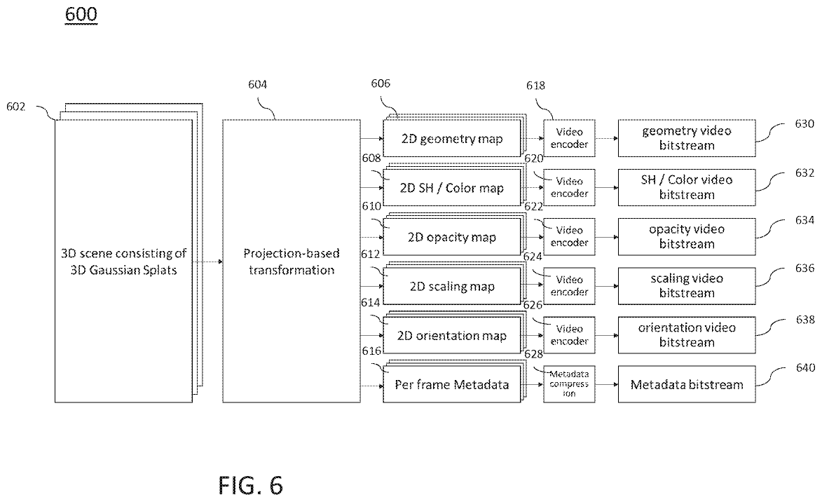

Referring to FIG. 6, a projection-based compression system and method is provided.

The disclosed embodiments are directed to, among other things, a system and method where 3DGS data is stored directly into images, i.e. without projection. Depending on the algorithms used to store the 3DGS data in 2D frames, this approach may generate 2D frames that are more suitable for video coding algorithms.

In some embodiments, a method to store 3DGS data in a V3C bitstream without projection is provided. The benefit of the proposed method is fast time-to-market as an already standardized method may be utilized with minimal modification to the decoder/renderer operation description. Additionally, existing tools may be leveraged to support coding of 3DGS data with little to no modification to high level syntax.

One existing tool in V3C is referred to as raw patches, which allows storing non-projected points as dedicated patches in a 2D frame. Raw patches were originally introduced to store points that are difficult to capture with projection, for example flying points or high-frequency geometry regions (e.g., representing hair). These high-frequency geometry regions are generally 3D regions where the points, when projected into planes, have no nearby neighbors, which results in poor video encoding performance. As such it has been considered as an additional tool to projected patches, which would store most of the 3D data. There is no profile support that would use raw patches as primary means for storing volumetric data and to indicate that the stored data should be interpreted as Gaussian splats.

Raw patches also provide information about the position of the patch in 3D space through rpdu_3d_offset_u, rpdu_3d_offset_v, rpdu_3d_offset_d syntax elements, reducing the number of bits required to represent the geometry values in 2D video component.

As shown in FIG. 3, raw patch 304 includes an attribute component that contains an unoccupied region 308 which does not carry any useful information but increase the pixel rate of the video component. This disclosure describes how to store 3DGS data in the raw patches and how to describe the interpretation of the decoded video data to minimize the pixel rate required by the bitstream.

In one example, an encoder device may receive volumetric data (e.g. 3DGS). The volumetric data may include one or more volumetric primitives for the volumetric data. Example primitive type index and primitive types are provided in Table 4.

TABLE 4

| primitive_type Index | Primitive type |
|---|---|
| 0 | 3D Gaussian Splat |
| 1 | 2D Gaussian Splat |
| 2 | Ellipsoids |
| 3 | Spheres |
| 4 | Billboards/Planes |
| 5 | Convex shapes |
| 6 | Generalized Gaussians |
| 7 | Meshlet |
| 8 | Cuboid |
| 9 | Half-Gaussians |
| 10 . . . 15 | RESERVED |

In some embodiments, the volumetric data may be quantized. Additionally, or alternatively, the volumetric data may be split into one or more 3D regions to enhance compression performance, enable spatial random access or to match quantization levels of available video codecs. After splitting, the volumetric data may be packed from the one or more 3D regions into one or more 2D regions in one or more 2D frames (without projecting it into planes). Packing may be performed, for example, using a reverse 3D Morton order into 1-d array, self-organizing grids, PLAS, or the like. Once packed, the 2D frames may be encoded with video or image codecs (e.g., JPEG, HEVC, AVC, VVC, VP8, VP9, AV1, AV2, etc.). The encoded 2D frames may be sent via a bitstream, such as a V3C bitstream. Signaled in or along the encoded one or more 2D frames may be information about the relation between the 2D regions in one or more 2D frames and the one or more 3D regions (i.e., how to access data in 2D frames and how reconstruct the 3D region).

Signaling of the encoded 2D frames may be performed utilizing atlas bitstream of V3C. A profile toolset may be set in V3C (e.g., ptl_profile_toolset_idc==2). In some embodiments, a profile indicates that the encoded video streams contain only/mostly non-projected volumetric data. Additionally, or alternatively, the profile indicates how xyz values are stored in the geometry video component. Further, the profile indicates how attribute values from a video component may be mapped to xyz values in geometry component.

V-DMC (ISO/IEC 23090-29) is another application form of V3C that aims on integration of mesh compression into the V3C family of standards. This approach consists of: generating a base-mesh that is a simplified (low resolution) mesh approximation of the original mesh, called base-mesh by performing zero or more mesh subdivision iterative steps (e.g., each triangle is converted into four triangles by connecting the triangle edge midpoints on the generated base mesh, generating other approximation meshes) and defining displacement vectors, for each vertex of each mesh approximation. The attribute map of the original mesh is transferred to the deformed mesh at the highest resolution such that texture coordinates are obtained for the deformed mesh and a new attribute map is generated.

The V-DMC encoder generates compressed bitstreams video bistreams, non-vide bitstreams and atlas bitstream. Non-video bitstream may contain the encoded base-mesh or displacement vectors. Video bitstream may contain the attribute maps or displacement vectors. Atlas bitstream, same as in other V3C application, carry information that enables the inverse reconstruction, from base mesh and a 2D video representations back to a full 3D representation.

In some embodiments, signaling may be performed using V-DMC application of V3C. In such scenario, geometry (x,y,z) may be stored in base-mesh component of V3C, e.g., without connectivity or with virtual connectivity (i.e., connectivity is randomly created or following a simple pattern that can be chosen by the encoder) or after tessellation of the positions (i.e., the positions are meshed using any well-known algorithm from the literature such as for example Poisson surface reconstruction or any other relevant). In that case any codec may be used to compress the geometry information instead of video codecs.

In some embodiments, two dimensional region may be signaled by SEI message of video codec. In this example, new SEI messages that enable the inverse reconstruction, from 2D video representations back to a full 3D representation may be defined and stored in or along the one of the video or image bitstreams representing two dimensional regions.

In some embodiments, signaling that enable the inverse reconstruction, from 2D video representations back to a full 3D representation may be performed using a dedicated box of a container format, such as ISOBMFF, or ISO Base Media File, associated with the encode one or more 2D frames (i.e. tracks or items). In some cases, new boxes may be defined and stored in an ISOBMFF file along with the video tracks or image items.

In some embodiments, signaling that enables the inverse reconstruction, from 2D video representations back to a full 3D representation may be performed using an attribute in session description protocol (SDP) associated with the encoding of the one or more 2D frames. SDP is a format that may be used to describe multimedia communication sessions. New attributes may be defined and stored in the SDP document along with video streams.

In some embodiments, signaling that enable the inverse reconstruction, from 2D video representations back to a full 3D representation may be performed using glTF extension associated with the encode one or more 2D frames. In some cases, new nodes may be defined and stored in the glTF file with the video bitstreams.

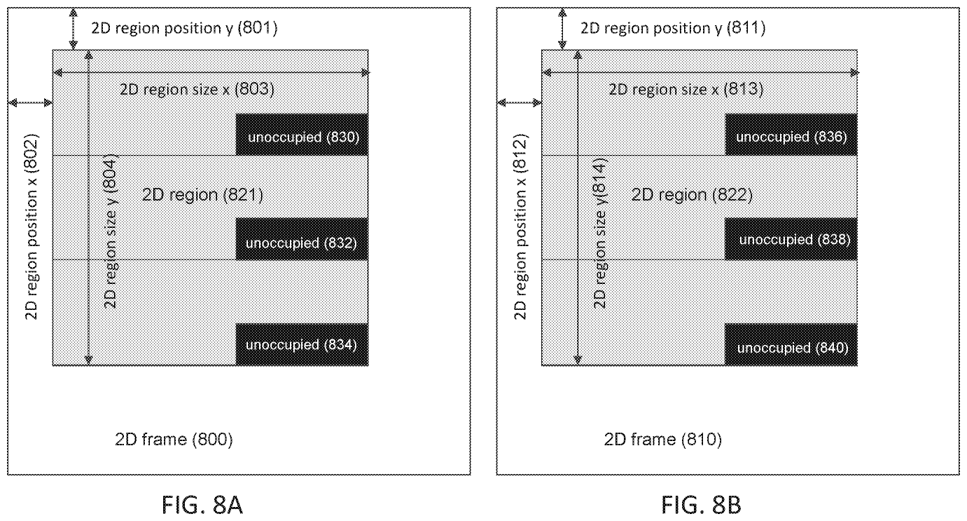

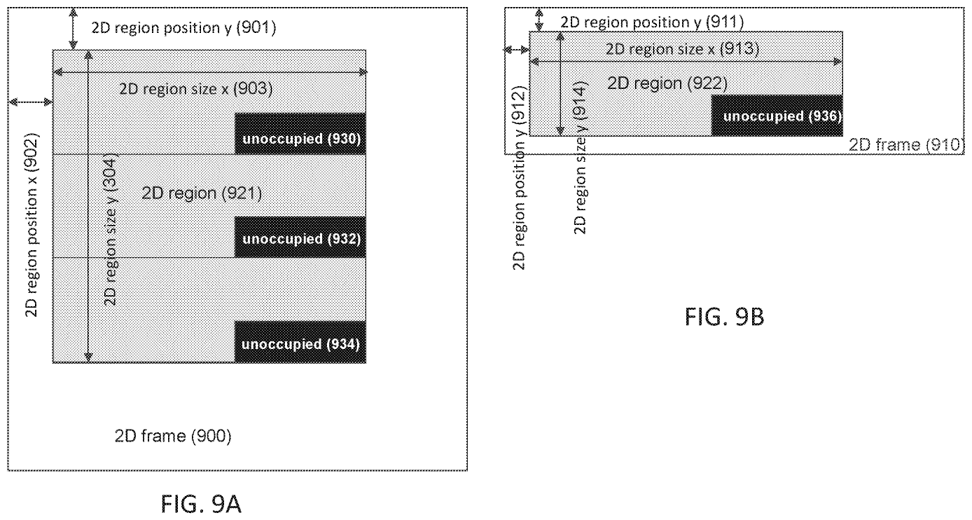

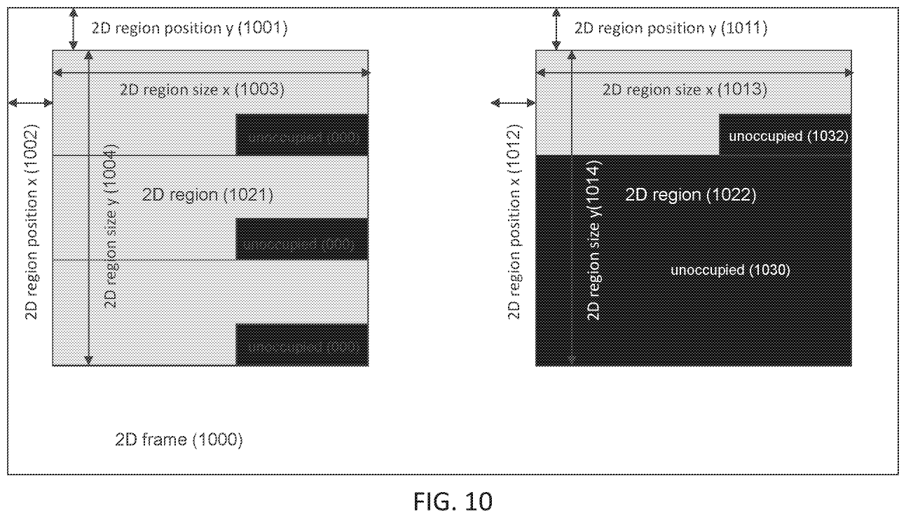

In some embodiments, efficient packing of visual and geometry attribute data in the 2D video frames is provided. The pixel rate should be as conservative as possible, thus there should be little to no unoccupied pixel data in the 2D frames (see FIG. 8 and FIG. 9). Similarly, the number of video codecs needed to decode the volumetric representation should be kept as low as possible. This would mean packing multiple components of the representation in the same frame (see FIG. 10).

In one example, a decoder device may receive one or more encoded 2D frames of imagery and associated metadata indicating that the one or more 2D frames of imagery contain volumetric primitives (such as 3DGS). The decoder may decode the 2D frames of imagery. Additionally, the decoder may decode the associated metadata (when it is encoded with V3C). Further, the decoder may recover the relationship between one or more 2D regions in the 2D frames and the one or more 3D regions from the associated metadata. Next, the decoder may reconstruct 3D position data (x,y,z) for volumetric primitives from the one or more 2D regions by applying 3D offsets from the associated metadata. Reconstruction may include reconstructing visual (color, opacity, spherical harmonics) and geometry (scale, rotation) attribute data for the volumetric primitives from the one or more 2D regions. Further, reconstruction may include reconstructing a volumetric representation by associating the 3D position data with the visual and geometry attribute data.

A benefit of the method described herein for 3DGS compression leveraging raw patches is its short time-to-market. Furthermore, it benefits from the systems around V3C that have been developed, and it also continues to leverage video codecs as the underlying compression technique.

In some embodiments, the decoder device may figure out what primitives a bitstream contains by receiving a bitstream, checking a profile within the bitstream, checking attributes of the bitstream, deciding what the primitive type should be based on the profile.

For readability of the document, we provide embodiments where volumetric video data is split to one 3D region that is mapped onto two 2D region which are mapped to two 2D frames. This split illustrates how 3D position (x,y,z) of volumetric primitives can be store in one video frame, and other attribute information (such as base color) is stored in the other 2D frame. A split that is familiar for V3C familiar reader. It should be noted that the embodiments can be extended to more than one 3D region and more than two 2D regions. In practice, it is highly likely that multiple 3D regions will be needed to efficiently store the volumetric primitives in the 2D patches due to quantization limits of video codecs and the arbitrary sizes of volumetric objects and scenes.

In one embodiment a 3D region is mapped to 2D regions described by raw patch of V3C. Indicate utilizing profile syntax elements of VPS that only raw patches shall be present in the atlas data and that the data carried by video component and described by atlas metadata is representing 3DGS data.

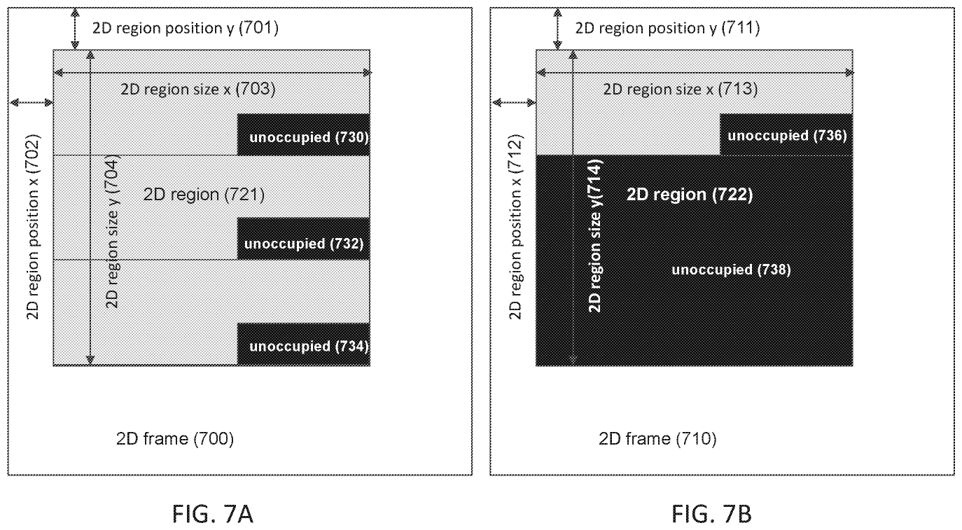

Referring to FIGS. 7A and 7B, in one embodiment, a 3D region is mapped to at least two 2D regions (721, 722) that are mapped to at least two 2D frames (700, 710). The 3D positions (x,y,z) of the volumetric primitives in the 3D region are stored in 2D region (721) with each component (x,y,z) starting at the beginning of the row. The 2D region (722) representing attribute information and only one component of the attribute per geometry point is provided. This could mean for example, only scaling for x-axis. The scaling values for y- and z-axes would be store in different 2D regions.

The position of the 2D region in 2D frame is signaled by 2D region position x and y (701, 702, 711, 712) that can be signal by rpdu_2d_pos_x rpdu_2d_pos_y, respectively plus tile position offset, if present.

The size of the 2D region in 2D frame is signaled by 2D region size x and y (703, 704, 713, 714) that can be signal by rpdu_2d_size_x_minus1 and rpdu_2d_size_y_minus1, respectively. 2D frames 700 and 710 include unoccupied regions 730, 732, 734, 736 and 738.

Referring to FIGS. 8A and 8B, in one embodiment a 3D region is mapped to at least two 2D regions (821, 822) that are mapped to at least two 2D frames (800, 810). The 3D positions (x,y,z) of the volumetric primitives in the 3D region are stored in 2D region (821) with each component starting at the beginning of the row. The 2D region (822) representing attribute information contain more than one component of the attribute per geometry point is provided. In this example, three attribute values are provided per geometry value. This could mean for example that all scaling related attribute values (x,y,z) are stored in the same 2D region, thus improving the pixel rate of the solution.

The position of the 2D region in 2D frame is signaled by 2D region position x and y (801, 802, 811, 812) that can be signal by rpdu_2d_pos_x rpdu_2d_pos_y, respectively plus tile position offset, if present.

The size of the 2D region in 2D frame is signaled by 2D region size x and y (803, 804, 813, 814) that can be signal by rpdu_2d_size_x_minus1 and rpdu_2d_size_y_minus1, respectively. 2D frames 800 and 810 include unoccupied regions 830, 832, 834, 836, 838 and 840.

Referring to FIGS. 9A and 9B, in one embodiment a 3D region is mapped to at least two 2D regions (921, 922) that are mapped to at least two 2D frames (900, 910). The 3D positions (x,y,z) of the volumetric primitives in the 3D region are stored in 2D region (921) with each component starting at the beginning of the row. The 2D region (922) representing attribute information contain one component of attribute per geometry point.

The position of the 2D region in 2D frame is signaled by 2D region position x and y (901, 902) that can be signaled by rpdu_2d_pos_x rpdu_2d_pos_y, respectively plus tile position offset, if present.

The position of the 2D region in 2D frame is signaled by 2D region position x and y (901, 902) that can be signaled by rpdu_2d_pos_x/3 rpdu_2d_pos_y/3, respectively plus tile position divided by 3 offset, if present.

The size of the 2D region in 2D frame is signaled by 2D region size x and y (903, 904) that can be signaled by rpdu_2d_size_x_minus1 and rpdu_2d_size_y_minus1, respectively.

The size of the 2D region in 2D frame is signaled by 2D region size x and y (913, 914) that can be signaled by rpdu_2d_size_x_minus1 and (rpdu_2d_size_y_minus1+1)/3, respectively. 2D frames 900 and 910 include unoccupied regions 930, 932, 934 and 936.

Referring to FIGS. 10A and 10B, in one embodiment a 3D region is mapped to at least two 2D regions (1021, 1022) that are mapped to one or more 2D frames (1000). The 3D positions (x,y,z) of the volumetric primitives in the 3D region are stored in 2D region (1021) with each component (x,y,z) starting at the beginning of the row. The 2D region (1022) representing attribute information and only one component of the attribute per geometry point is provided. This could mean for example, only scaling for x-axis. The scaling values for y- and z-axes would be store in different 2D regions.

The position of the first 2D region in 2D frame is signaled by 2D region position x and y (1001, 1002) that can be signaled by rpdu_2d_pos_x rpdu_2d_pos_y, respectively plus tile position offset, if present. The position x and y (1011, 1012) for the 2nd would be derived based on the packing_information syntax structure as defined in ISO/IEC 23090-5.

The size of the 2D region in 2D frame is signaled by 2D region size x and y (1003, 1004, 1013, 1014) that can be signaled by rpdu_2d_size_x_minus1 and rpdu_2d_size_y_minus1, respectively.

In one embodiment a signaling information, e.g. through profile, provide information how to interpret values in 2D region of video component geometry vide. I.e., x,y and z are stored as specified in ISO/IEC 23090-5 or if each component starts with new profile.

In one embodiment a signaling information, e.g. through profile or attribute type provide information on how to store given attribute in 2D frame and how to interpret the 2D region.

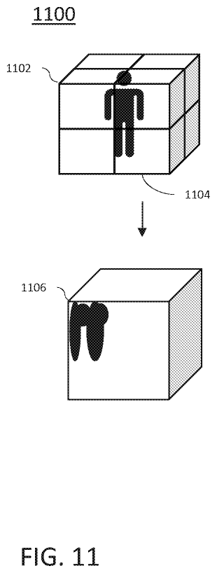

In one embodiment, multiple 3D regions are considered, for example to provide random access to portions of a scene, in one example this can be a regular division of the scene 3D space into sub-regions that are overlapping or not. Referring to FIG. 11, diagram 1100 shows a 3D space 1102. A sub-region 1104 of 3D space may be split from the 3D space to generate sub-region 1106. In one embodiment, the 2D regions of video components of the same 3D region may be mapped to a specific region of the video component, for example a tile that can be encoded as a VVC subpicture or a HEVC MCTS tile, or a HEVC or VVC slice. In a practical implementation, such a division is likely needed due to quantization limits of video codecs. Without multiple 3D regions, AVC for example would only support storage of 8-bit position values for x, y and z.

In another embodiment, Gaussian splats of a 3D region may be separated into multiple clusters, for example to provide a Level of Detail functionality. In one example, points are classified between three LoDs LOD0, LOD 1 and LOD2.

In one embodiment a new toolset profile for raw patch only compression of V3C is defined. The toolset profile component for this profile, could be allocated for an existing application of V3C such as V-PCC for example, or a new toolset profile component can be defined for 3DGS specifically.

Table 5 provides a list of defined toolset profile components for V3C and their corresponding identifying syntax element values, e.g. ptl_profile_toolset_idc and ptc_one_v3c_frame_only flag, that are defined for use by this document. A new ptl_profile_toolset_idc for raw patch only compression has been added to the table as an example.

TABLE 5
Available toolset profiles as defined in ISO/IEC 23090-5

| | | Toolset profile | |
|---|---|---|---|
| ptl_profile_toolset_idc | ptc_one_v3c_frame_only_flag | component | Type |
| 0 | 0 | V-PCC Basic | Dynamic |
| | 1 | V-PCC Basic Still | Static |
| 1 | 0 | V-PCC Extended | Dynamic |
| | 1 | V-PCC Extended Still | Static |
| 2 | 0 | V-PCC Raw Patch | Dynamic |
| | | Only | |
| | 1 | V-PCC Raw Patch | Still |
| | | Only Still | |
| 64 | 0 | MIV Main/* | Dynamic |
| | | Specified in | |
| | | ISO/IEC 23090-12 */ | |
| | 1 | MIV Main Still/* | Static |
| | | Specified in | |
| | | ISO/IEC 23090-12 */ | |
| 65 | 0 | MIV Extended/* | Dynamic |
| | | Specified in | |
| | | ISO/IEC 23090-12 */ | |
| | | MIV Extended Still/* | Static |
| | | Specified in | |
| | | ISO/IEC 23090-12 */ | |
| 66 | 0 | MIV Geometry Absent/* | Dynamic |
| | | Specified in | |
| | | ISO/IEC 23090-12 */ | |
| | 1 | MIV Geometry Absent | Static |
| | | Still/* | |
| | | Specified in | |
| | | ISO/IEC 23090-12 */ | |
| 67 . . . 79 | — | /* Specified in | — |
| | | ISO/IEC 23090-12 */ | |
| 128 . . . 143 | — | /* Specified in | — |
| | | ISO/IEC 23090-29 */ | |
| 3 . . . 63, 80 . . . 127, | — | Reserved | — |
| 144 . . . 255 | | | |

V3C toolset profiles for V-PCC would need to be appended as follows.

V3C toolset profile components indicating the V-PCC Basic (ptl_profile_toolset_idc=0), V-PCC Basic Still (ptl_profile_toolset_idc=0 and ptc_one_v3c_frame_only_flag=1), V-PCC Extended (ptl_profile_toolset_idc=1), V-PCC Extended Still (ptl_profile_toolset_idc=1 and ptc_one_v3c_frame_only_flag=1), V-PCC Raw Patch Only (ptl_profile_toolset_idc=2) and V-PCC Raw Patch Only Still (ptl_profile_toolset_idc=2 and ptc_one_v3c_frame_only_flag=1) toolset profile component shall conform to the syntax element restrictions specified in Table 4. If a syntax element is not mentioned in Table 6 it is not restricted through a toolset profile component.

TABLE 6
An example of max allowed syntax element values for the V-PCC toolset profile components.

| | Profile name | | | | | |
|---|---|---|---|---|---|---|
| | | | | | | V-PCC |
| | | V-PCC | | V-PCC | V-PCC | Raw |
| | V-PCC | Basic | V-PCC | Extended | Raw | Only |
| Syntax element | Basic | Still | Extended | Still | Only | Still |
| ptl_profile_toolset_idc | 0 | 0 | 1 | 1 | 2 | 2 |
| ptc_one_v3c_frame_only_flag | — | 1 | — | 1 | — | 1 |

| | | | |
|---|---|---|---|
| asps_eom_patch_enabled_flag | 0 | — | 0 |
| vps_map_count_minus1 | Min(1, LevelMapCount − 1) | LevelMapCount − 1 | 0 |
| vps_multiple_map_streams_present_flag | when present, 1 | — | — |
| asps_miv_2_extension_present_flag | 0 | 0 | 0 |
| asps_vdmc_extension_present_flag | 0 | 0 | 0 |
| casps_extension_present_flag | 0 | 0 | 0 |
| casps_miv_extension_present_flag | 0 | 0 | 0 |
| casps_miv_2_extension_present_flag | 0 | 0 | 0 |
| caf_extension_present_flag | 0 | 0 | 0 |
| caf_miv_extension_present_flag | 0 | 0 | 0 |
| vuh_unit_type | V3C_VPS, | V3C_VPS, | V3C_VPS, |
| | V3C_AD, | V3C_AD, | V3C_AD, |
| | V3C_OVD, | V3C_OVD, | V3C_GVD, |
| | V3C_GVD, | V3C_GVD, | or |
| | or | or | V3C_AVD |
| | V3C_AVD | V3C_AVD | |

### ADDITIONAL CONSIDERATIONS

In accordance with one example, an apparatus is provided comprising at least one processor and at least one memory storing instructions that, when executed with the at least one processor, cause the apparatus to perform: (i) receiving volumetric data, wherein the volumetric data consists of a plurality of three dimensional primitives corresponding to one or more three dimensional regions, (ii) packing quantized geometry and visual attributes of the three dimensional primitives of the at least one three dimensional region of the plurality of three dimensional regions to at least one two dimensional region of a first image and at least one two dimensional region of a second image without projecting the three dimensional primitives in two dimensional planes, (iii) forming at least one bitstream comprising the first image, the second image, and metadata, wherein the metadata indicates at least one relationship between the at least one three dimensional region and the at least one two dimensional region of the first image and the at least one two dimensional region of the second image, and (iv) signaling a profile in the metadata indicating that the quantized geometry and visual attributes of the three dimensional primitives in the at least one three dimensional regions were directly stored in the at least one two dimensional region in the first image and the at least one two dimensional region of the second image.

In accordance with the example embodiment, the at least one three dimensional region is split from the received volumetric data to enhance compression performance.

In accordance with the example embodiment, the at least one three dimensional region is split from the received volumetric data to enable spatial random access.

In accordance with the example embodiment, the at least one three dimensional region is split from the received volumetric data to match a quantization level of at least one of a plurality of video codecs.

In accordance with the example embodiment, three dimensional positions of primitives of the at least one three dimensional region are stored in the at least one two dimensional region of the first image.

In accordance with the example embodiment, the quantized geometry and visual attributes of the three dimensional primitives of the at least one three dimensional region is stored in the at least one two dimensional region of the second image.

In accordance with the example embodiment, volumetric data includes data for at least one of a three dimensional Gaussian Splat, an ellipsoid, a sphere, a billboard, a plane, a convex shape, a general Gaussian, a meshlet, a cuboid, or a half-Gaussian.

In accordance with the example embodiment, the at least one relationship indicates how to reconstruct the at least one three dimensional region from data stored in the first image and the second image.

In accordance with the example embodiment, the at least one relationship comprises of at least the three dimensional offsets of the three dimensional information region and the two dimensional offsets of the two dimensional region.

In accordance with the example embodiment, the profile is signaled using a visual volumetric video-based coding bitstream.

In accordance with the example embodiment, the profile indicates that the at least one bitstream contains non-projected volumetric data.

In accordance with the example embodiment, a flag in the visual volumetric video-based coding bitstream indicates that the bitstream contains only non-projected patches.

In accordance with the example embodiment, the profile or flag in the visual volumetric video-based coding bitstream indicates that the at least one bitstream contains only raw patches.

In accordance with the example embodiment, the profile indicates how at least one positional primitive data value of the volumetric data is stored in the first image.

In accordance with the example embodiment, the profile indicates how the quantized geometry and visual attributes of the three dimensional primitives of the at least one three dimensional region are mapped to at least one region of the second image.

In accordance with the example embodiment, the profile is signaled with at least one supplemental enhancement information message of a video codec, wherein the first image and the second image are encoded using the video codec.

In accordance with the example embodiment, the at least one bitstream is a visual volumetric video-based coding bitstream.

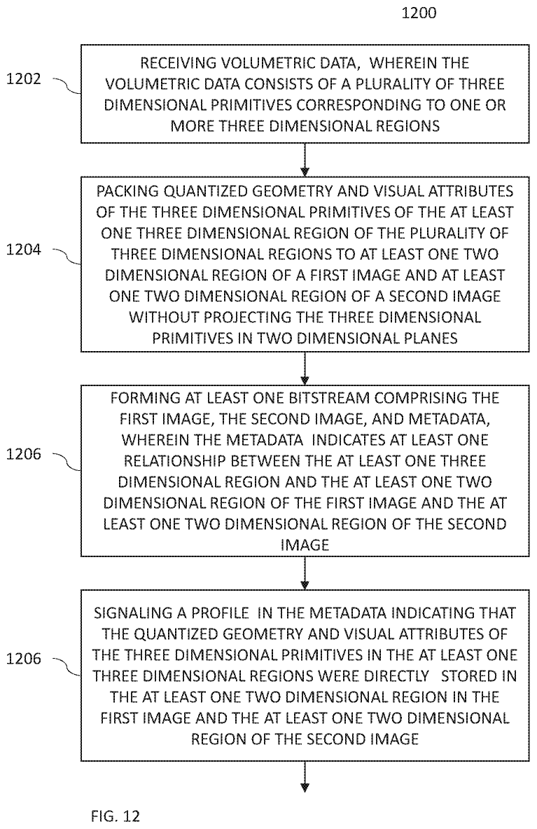

FIG. 12 illustrates an example method 1200 of hybrid decoding attributes of rendering primitives. Method 1200 may be implemented by encoder 130 where encoder 130 is an instance of user equipment 102 (all shown in FIG. 1). While FIG. 12 will be discussed in the context of FIG. 1, this is for clarity of explanation purposes only and the method described in FIG. 12 should not be considered limited by the components illustrated in FIG. 1. Method 1200 may be implemented by a processor, such as processor 106 of FIG. 1. Method 1200, at 1202, may include processor 106 receiving volumetric data, wherein the volumetric data consists of a plurality of three dimensional primitives corresponding to one or more three dimensional regions. Method 1200, at 1204, may include processor 106 packing quantized geometry and visual attributes of the three dimensional primitives of the at least one three dimensional region of the plurality of three dimensional regions to at least one two dimensional region of a first image and at least one two dimensional region of a second image without projecting the three dimensional primitives in two dimensional planes. Method 1200, at 1206, may include processor 106 forming at least one bitstream comprising the first image, the second image, and metadata, wherein the metadata indicates at least one relationship between the at least one three dimensional region and the at least one two dimensional region of the first image and the at least one two dimensional region of the second image. Method 1200, at 1208, may include processor 106 signaling a profile in the metadata indicating that the quantized geometry and visual attributes of the three dimensional primitives in the at least one three dimensional regions were directly stored in the at least one two dimensional region in the first image and the at least one two dimensional region of the second image.

In accordance with another example, an apparatus is provided comprising at least one processor and at least one memory storing instructions that, when executed with the at least one processor, cause the apparatus to perform: (i) receiving at least one bitstream, the at least one bitstream comprising at least one two dimensional region of a first image, at least one two dimensional region of a second image, and metadata, (ii) decoding the at least one two dimensional region of the first image and the at least one two dimensional region of the second image based on an indication signaled by the profile in the metadata, and (iii) reconstructing volumetric data based at least in part on the profile in the metadata, and the metadata which indicates at least one relationship between at least one three dimensional region of the volumetric data and the at least one two dimensional region of the first image and the at least one two dimensional region of the second image.

In accordance with the example embodiment, metadata of the at least one bitstream signals that at least one of the first image and the second image contain at least one rendering primitive for the at least one three dimensional region of the volumetric data.

In accordance with the example embodiment, reconstructing volumetric data comprises reconstructing a three dimensional offset value for the at least one three dimensional region of the volumetric data from at least one region of the first image and the second image.

In accordance with the example embodiment, reconstructing volumetric data comprises reconstructing a three dimensional position data value for the at least one three dimensional primitive in a three dimensional region of the volumetric data which further comprises applying the at least one three dimensional offset.

In accordance with the example embodiment, reconstructing volumetric data comprises reconstructing at least one visual attribute data value for the at least one three dimensional primitive in a three dimensional region of the volumetric data from at least one region of the first image and the second image.

In accordance with the example embodiment, the at least one visual attribute data value is color, opacity, or spherical harmonics.

In accordance with the example embodiment, reconstructing volumetric data comprises reconstructing at least one geometry attribute data value for the at least one three dimensional region of the volumetric data from at least one region of the first image and the second image.

In accordance with the example embodiment, the at least one geometry attribute data value is scale or rotation.

In accordance with the example embodiment, reconstructing volumetric data comprises associating at least one geometry attribute data value for the at least one three dimensional region of the volumetric data with a three dimensional position data value for the at least one three dimensional region of the volumetric data.

In accordance with the example embodiment, reconstructing volumetric data comprises associating at least one visual attribute data value for the at least one three dimensional region of the volumetric data with a three dimensional position data value for the at least one three dimensional region of the volumetric data.

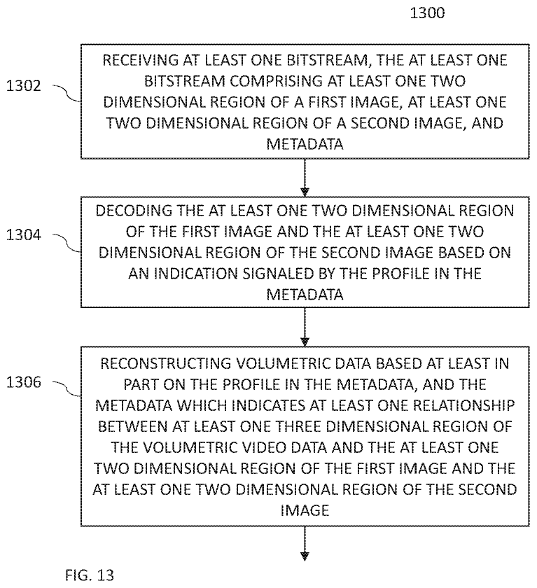

FIG. 13 illustrates an example method 1300 of hybrid decoding attributes of rendering primitives. Method 1300 may be implemented by encoder 130 where encoder 130 is an instance of user equipment 102 (all shown in FIG. 1). While FIG. 13 will be discussed in the context of FIG. 1, this is for clarity of explanation purposes only and the method described in FIG. 13 should not be considered limited by the components illustrated in FIG. 1. Method 1300 may be implemented by a processor, such as processor 106 of FIG. 1. Method 1300, at 1302, may include processor 106 receiving at least one bitstream, the at least one bitstream comprising at least one two dimensional region of a first image, at least one two dimensional region of a second image, and metadata. Method 1300, at 1304, may include processor 106 decoding the at least one two dimensional region of the first image and the at least one two dimensional region of the second image based on an indication signaled by the profile in the metadata. Method 1300, at 1306, may include processor 106 reconstructing volumetric data based at least in part on the profile in the metadata, and the metadata which indicates at least one relationship between at least one three dimensional region of the volumetric data and the at least one two dimensional region of the first image and the at least one two dimensional region of the second image.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. An apparatus comprising: at least one processor; and at least one memory storing instructions that, when executed with the at least one processor, cause the apparatus to perform: receiving volumetric data, wherein the volumetric data consists of a plurality of three dimensional primitives corresponding to one or more three dimensional regions; packing quantized geometry and visual attributes of the three dimensional primitives of the at least one three dimensional region of the plurality of three dimensional regions to at least one two dimensional region of a first image and at least one two dimensional region of a second image without projecting the three dimensional primitives in two dimensional planes; forming at least one bitstream comprising the first image, the second image, and metadata, wherein the metadata indicates at least one relationship between the at least one three dimensional region and the at least one two dimensional region of the first image and the at least one two dimensional region of the second image; and signaling a profile in the metadata indicating that the quantized geometry and visual attributes of the three dimensional primitives in the at least one three dimensional regions were directly stored in the at least one two dimensional region in the first image and the at least one two dimensional region of the second image.

2. The apparatus of claim 1, wherein the profile is signaled using a visual volumetric video-based coding bitstream.

3. The apparatus of claim 2, wherein the profile indicates that the at least one bitstream contains non-projected volumetric data.

4. The apparatus of claim 3, wherein a flag in the visual volumetric video-based coding bitstream indicates that the bitstream contains only non-projected patches.

5. The apparatus of claim 4, wherein the profile or flag in the visual volumetric video-based coding bitstream indicates that the at least one bitstream contains only raw patches.

6. An apparatus comprising: at least one processor; and at least one memory storing instructions that, when executed with the at least one processor, cause the apparatus to perform: receiving at least one bitstream, the at least one bitstream comprising at least one two dimensional region of a first image, at least one two dimensional region of a second image, and metadata; decoding the at least one two dimensional region of the first image and the at least one two dimensional region of the second image based on an indication signaled by the profile in the metadata; and reconstructing volumetric data based at least in part on the profile in the metadata, and the metadata which indicates at least one relationship between at least one three dimensional region of the volumetric data and the at least one two dimensional region of the first image and the at least one two dimensional region of the second image.

7. The apparatus of claim 6, wherein the metadata of the at least one bitstream signals that at least one of the first image and the second image contain at least one rendering primitive for the at least one three dimensional region of the volumetric data.

8. The apparatus of claim 6, wherein reconstructing volumetric data comprises reconstructing a three dimensional offset value for the at least one three dimensional region of the volumetric data from at least one region of the first image and the second image.

9. The apparatus of claim 6, wherein reconstructing volumetric data comprises reconstructing a three dimensional position data value for the at least one three dimensional primitive in a three dimensional region of the volumetric data which further comprises applying the at least one three dimensional offset.

10. The apparatus of claim 6, wherein reconstructing volumetric data comprises reconstructing at least one visual attribute data value for the at least one three dimensional primitive in a three dimensional region of the volumetric data from at least one region of the first image and the second image.

11. The apparatus of claim 6, wherein reconstructing volumetric data comprises reconstructing at least one geometry attribute data value for the at least one three dimensional region of the volumetric data from at least one region of the first image and the second image.

12. The apparatus of claim 6, wherein reconstructing volumetric data comprises associating at least one geometry attribute data value for the at least one three dimensional region of the volumetric data with a three dimensional position data value for the at least one three dimensional region of the volumetric data.

13. The apparatus of claim 6, wherein reconstructing volumetric data comprises associating at least one visual attribute data value for the at least one three dimensional region of the volumetric data with a three dimensional position data value for the at least one three dimensional region of the volumetric data.

14. The apparatus of claim 6, wherein reconstructing volumetric data comprises associating at least one geometry attribute data value and at least one visual attribute data value for the at least one three dimensional region of the volumetric data with a three dimensional position data value for the at least one three dimensional region of the volumetric data.

15. The apparatus of claim 6, wherein the profile is signaled using a visual volumetric video-based coding bitstream.

16. The apparatus of claim 6, wherein the profile indicates that the at least one bitstream contains non-projected volumetric data.

17. The apparatus of claim 6, wherein the profile indicates how at least one positional primitive data value of the volumetric data is stored in the first image.

18. The apparatus of claim 6, wherein the profile indicates how at least one attribute value of the volumetric data is mapped to at least one region of the second image.

19. The apparatus of claim 6, wherein the profile is signaled with at least one supplemental enhancement information message of a video codec, wherein the first image and the second image are decoded using the video codec.

20. A method comprising: receiving at least one bitstream, the at least one bitstream comprising at least one two dimensional region of a first image, at least one two dimensional region of a second image, and metadata; decoding the at least one two dimensional region of the first image and the at least one two dimensional region of the second image based on an indication signaled by the profile in the metadata; and reconstructing volumetric data based at least in part on the profile in the metadata, and the metadata which indicates at least one relationship between at least one three dimensional region of the volumetric data and the at least one two dimensional region of the first image and the at least one two dimensional region of the second image.
